(19) United States
(12) Patent Application Publication
(10) Pub. No.: US 2018/0152903 A1
(43) Pub. Date: May 31, 2018

(54) REAL-TIME WIRELESS POSITIONING SYSTEM AND METHOD THEREOF

(71) Applicant: INTRAPOSITION LTD., Even-Yehuda (IL)

(72) Inventors: Yaron SHAVIT, Even-Yehuda (IL); Arie STAR, Hadera (IL); Dan SEGAL, Givataim (IL); Yonathan NATIV, Ra'anana (IL)

(21) Appl. No.: 15/576,367

(22) PCT Filed: May 8, 2016
(86) PCT No.: PCT/IL2016/050484

§ 371 Date: Nov. 22, 2017

Related U.S. Application Data
(60) Provisional application No. 62/166,153, filed on May 26, 2015.

(51) Int. Cl. H04W 56/00; H04L 7/00; G01S 5/02; G01S 5/10

(52) U.S. Cl. CPC H04W 56/002; H04W 56/006; G01S 5/10; G01S 5/021; G01S 5/0226; H04L 7/0025

(57) ABSTRACT

A real-time wireless positioning system, comprising: a plurality of portable tag devices; a plurality of autonomous reference transmitters installed in a defined area housing said plurality of tag devices; a plurality of anchors installed in a defined area housing said plurality of tag devices and said a plurality of autonomous reference transmitters; and at least one location engine unit in an area housing said plurality of tag devices, said a plurality of autonomous reference transmitters and said plurality of anchors.

### FIELD OF THE INVENTION

The present invention relates generally to a system and method to realize a continuous synchronization in wireless positioning systems, and, in particular, to continuous clock synchronization in a wireless TDOA locating system.

### BACKGROUND OF THE INVENTION

Wireless technology continues to proliferate in view of strong consumer demand. For example, many apparatuses now incorporate wireless communication features that allow these devices to interoperate by transmitting and receiving wireless messages. A plurality of apparatuses interacting in this matter may be deemed to be operating within a wireless network. Network operation may allow apparatuses to exchange information while realizing benefits such as enhanced communication speed and/or data-handling capacity, error correction, security, etc.

Example networks may be implemented using wireless communication protocols that govern how participating apparatuses may interact. Wireless communication protocols may operate over long distances (e.g., cellular), short distances (e.g., Bluetooth, wireless local area networking (WLAN), etc.) or even in close-proximity situations (e.g., near field communication (NFC), etc.). One aspect that may influence the operation of such communication transports is synchronization (e.g., computing an offset of absolute time with respect to other apparatuses in the network). For instance, each networked apparatus may operate based on its own clock. However, communication between the apparatuses may be negatively impacted if the clocks are not synchronized. For example, clock synchronization may be important for managing network communication activities such as channel access, apparatus mode control (e.g., transmit/receive mode, sleep mode, etc.), interference (e.g., collision) prevention, packet retransmission, etc.

Applications such as Time Difference of Arrival (TDOA) or Time of Arrival (TOA) methods for location determination rely on tight synchronization of the clocks of a plurality of devices such as access points. For example with TDOA for every nanosecond of uncertainty between access point (AP) clocks there is approximately a foot of uncertainty in the spatial solution. AP clocks for example are naturally unsynchronized because of slight differences in the quartz crystals used to set clock frequencies. In addition, clock variations may occur due to temperature, age and clock jitter. One solution for providing clock synchronization is distributing a clock, or clock synchronization signals, via wires between the APs. This solution provides very precise and reliable synchronization, but adds difficulty and expense to deployment of the network and is inflexible regarding the repositioning of the APs over time. Another solution is synchronizing APs through a wireless method, making deployment less expensive and more flexible regarding the repositioning of the APs over time. While wireless synchronization adds flexibility and reduces cost, it suffers from the unreliability of the wireless medium. For example, in some facilities, such as large manufacturing facilities, the line of sight between wireless devices may be interrupted, for example by the movement of a large overhead crane. In addition, multipath between wireless devices may also introduce error in synchronizing clocks.

US Patent Publication No. 2012/0120874, published on May 17, 2012, by McLaughlin, discloses in an ultra-wideband (“UWB”) network, a central location engine (“CLE”) coordinates operation of an anchor access point (“AP”), AP[0], and a plurality of non-anchor AP[x]s. A clock calibration packet (“CCP”) transmission method and related apparatus facilitate normalization of CCP time references reported to the CLE by all APs. Implementing a digital phase locked loop (“DPLL”) in the CLE facilitates clock normalization. Implementing a DPLL in at least the non-anchor AP[x]s facilitates local clock synchronization, and may improve network efficiency by reducing clock synchronization traffic.

US Patent Publication No. 2008/0075061, published on Mar. 27, 2008, discloses a method for synchronizing a clock signal in a basestation of a wireless telecommunications system is described. The basestation has a reference clock signal and is operable to communicate with wireless mobile terminals and with a packet switched network. The method comprises detecting a radio frequency clock synchronization signal from a wireless telecommunications network, and synchronizing the reference clock signal of the basestation in dependence upon the detected radio frequency clock synchronization signal.

US Patent Application No. 2008/0287153, published on Nov. 20, 2008, discloses a method of clock synchronization for a wireless communications system includes receiving a radio frequency (RF) signal at a base station and at a network reference server (NRS). The NRS is also coupled to receive a reference clock signal. A clock offset value is then calculated in response to the RF signal received at the base station, the RF signal received at the NRS, and the reference clock signal. A local clock signal at the base station is then synchronized with the reference clock signal in response to the calculated clock offset value.

EP Patent Publication No. 2661010, published on Nov. 6, 2013, discloses a method of time synchronization and a base station system. The base station system includes a main unit, at least one radio unit, and an optical fiber adapted to transmit information between the main unit and the at least one radio unit. The base station system further includes a clock synchronization server configured close to the side of the at least one radio unit or integrated with the at least one radio unit. The clock synchronization server is adapted to transmit synchronization data with the main unit through the optical fiber, so that the main unit performs configuration processing according to the synchronization data to implement time synchronization with the clock synchronization server. With the solution provided in the present invention, time is synchronized between the main unit and the clock synchronization server, so that it is more flexible and convenient to select a main unit site of the system, and devices are simple and the cost is low.

In addition to the basic functionality discussed above, more complex functionality may also be influenced by clock synchronization. For example, the distance between networked apparatuses may be estimated based on message transmission duration and signal transmission speed. However, the accuracy of such estimations may be adversely affected when the clocks in apparatuses that are creating reception and transmission timestamps are not synchronized. The above approaches are limited in various ways. They utilize features that may require complex electronics and/or give rise to errors, and/or rely on expensive clocks. The modification of the network architecture in the present invention improves network scalability, robustness and efficiency.

There is no decentralized system disclosed in the prior art that provides a continuous influx of sync data received by a location engine unit/server from a cluster of installed in fixed defined positions devices to maintain a high level of redundancy and robustness. This data can be used to synchronize the transmitter units in real-time and/or off-line manner, when required.

Therefore, there is a long felt and unmet need for a system and method that overcomes TDOA Location Systems Wireless synchronization methods and architectures suggested in the prior art that are centralized and lack the redundancy which is highly desirable in order to achieve system robustness. The system and method will provide a real time wireless continuous synchronization of the anchors which uses autonomous reference transmitters' signals to exactly locate a unit being tracked or located in an area.

### SUMMARY

It is hence one object of this invention to disclose a real-time wireless positioning system, comprising: a plurality of portable tag devices; a plurality of autonomous reference transmitters installed in a defined area housing said plurality of tag devices; a plurality of anchors installed in a defined area housing said plurality of tag devices and said a plurality of autonomous reference transmitters; and at least one location engine unit in a defined area housing said plurality of tag devices, said a plurality of autonomous reference transmitters and said plurality of anchors; each tag device, being spaced apart at a predetermined cluster separation distance from each other, is adapted to store a unique identification code, each tag device is adapted to transmit one or more of positioning blinks when activated; at least one reference transmitter, being spaced apart at a predetermined cluster separation distance from each other, is adapted to transmit periodically one or more of synchronization blinks, said one or more of synchronization blinks comprising reference transmitter identification code and blink identification code; any anchor in range of an activated tag device is adapted to receive said synchronization blinks and transmit synchronization blink data, said data comprising its TOA at the anchor, the transmitter unique identification and the receiving anchor unique identification code, to at least one location engine unit; at least one location engine is adapted to receive said synchronization blink data and said positioning blink data transmitted by said at least one anchors in range of said activated tag device and calculate a location of the tag device transmitting said positioning blink based on Time Difference of Arrival; anchors' clocks synchronization functions are continuously maintained, by means of linear or nonlinear regression, based on synchronization blink data influx

It is another object of the current invention to disclose a method for time synchronization in a real-time wireless positioning system, wherein said method comprising steps of: transmitting one or more of positioning blinks by tag device when activated; transmitting periodically one or more of synchronization blinks, said blink comprising reference transmitter identification code and blink identification code; receiving said synchronization blinks by at least one anchor and transmitting synchronization blink data, said data comprising its TOA at the anchor and the transmitter unique identification and the receiving anchor unique identification code , to at least one location engine unit; receiving said synchronization blink data and said positioning blink data transmitted by said at least one anchors in range of said activated tag device and calculating a location of the tag device transmitting said positioning blink based on Time Difference of Arrival; continuously maintaining anchors' clocks synchronization functions, by means of linear or nonlinear regression, based on synchronization blink data influx

It is another object of the current invention to disclose an apparatus for time synchronization in a real-time wireless positioning system, comprising: at least one processor; and at least one memory including executable instructions, the at least one memory and the executable instructions being configured to, in cooperation with the at least one processor, cause the device to perform at least the following: transmitting periodically one or more of synchronization blinks, said blink comprising reference transmitter identification code and blink identification code; receiving, by at least one anchor, said blink and transmitting said blink to a location engine unit; receiving said synchronization blinks and transmitting synchronization blink data, said data comprising its TOA at the anchor and the transmitter unique identification and the receiving anchor unique identification code, to at least one location engine unit.

It is another object of the current invention to disclose an apparatus for time synchronization in a real-time wireless positioning system, comprising: means for transmitting one or more of positioning blinks by tag device when activated; means for transmitting periodically one or more of synchronization blinks by a reference transmitter, said blink comprising reference transmitter identification code and blink identification code; means for receiving, by at least one anchor, said blink and transmitting said blink to a location engine unit; means for receiving said synchronization blinks and transmitting synchronization blink data, said data comprising its TOA at the anchor and the transmitter unique identification and the receiving anchor unique identification code, to at least one location engine unit; means for receiving said synchronization blink data and said positioning blink data transmitted by said at least one anchors in range of said reference transmitter and said activated tag device respectively and calculating a location of the tag device transmitting said positioning blink based on Time Difference of Arrival; means for continuously maintaining anchors' clocks synchronization functions, by means of linear or nonlinear regression, based on synchronization blink data influx

### BRIEF DESCRIPTION OF THE FIGURES

In the following detailed description of the preferred embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

FIG. 1 schematically presents, in topological form, a system environment according to the present invention;

FIG. 2 schematically presents, in topological form, a system according to the present invention;

FIG. 3 is a flow diagram illustrating a method for time synchronization in a real-time wireless positioning system;

FIG. 4 is a flow diagram illustrating a method calculating tag position in a real-time wireless positioning system.

### DETAILED DESCRIPTION OF THE INVENTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In a wireless communication network, one or more base transmitters are selectively positioned within respective geographic coverage areas or cells. These transmitters are used to transmit and receive communication signals to and from mobile/tag devices located within a respective cell. In particular, the transmitters act as intermediary points by which a communication path may be periodically established and maintained between mobile/tag devices, as well as between a mobile/tag device and an end point of a location engine unit.

There are a variety of a communication protocols in which mobile/tag devices can communicate with anchors of the communication network. For example, Code Division Multiple Access (CDMA), Time Division Multiple Access (TDMA), and Universal Mobile Telecommunications System (UMTS) are all well known communication protocols. Of concern with the selection of a communication protocol is the ability of the mobile/tag device to communicate with anchors in a simple, flexible and rapid manner. In this respect, the ability to acquire and maintain synchronization between anchors is an important consideration.

The term “synchronization blink” interchangeably refers hereinafter to any wireless message and/or signal transmitted by a transmitter, by electromagnetic waves, such as a periodic or cyclical timestamp, comprising exact timing transmission measures and/or reception time's measures in order to provide system synchronization. Thus, the timestamp may provide a unique reference upon which location engine units may base their calculations.

The term “positioning blink” interchangeably refers hereinafter to any wireless message and/or signal transmitted by a tag device, by electromagnetic waves, that determines and/or makes use of one or more positioning parameters associated with one or more wireless positioning signals as received from one or more transmitting devices.

The term “TOA” interchangeably refers hereinafter to any reception time and/or reception timestamp data indicating time of reception of the timing advance response blink/message at the wireless receiver device/s.

The term “anchor” interchangeably refers hereinafter to any fixed communications location point and is part of a network's wireless system. It relays information from a transmitting unit, such as a tag device/s and/or reference transmitter/s. The term “location engine unit” interchangeably refers hereinafter to any computing unit and/or server and/or cloud server including a computing service provider, a communication unit and a processing unit. The computing service provider is configured to provide a computing service to calculate a location of the tag device transmitting said positioning blink based on Time Difference of Arrival and to calculate time synchronization functions of the anchor device/s.

The term “housing area” interchangeably refers hereinafter to any present system network perimeter comprising disclosed anchors and/or location engine unit and/or reference transmitters and/or tags in close and/or remote proximity.

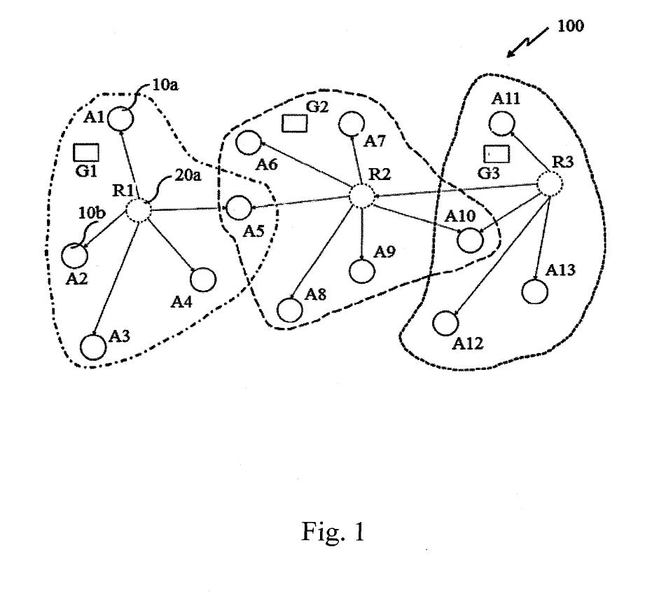

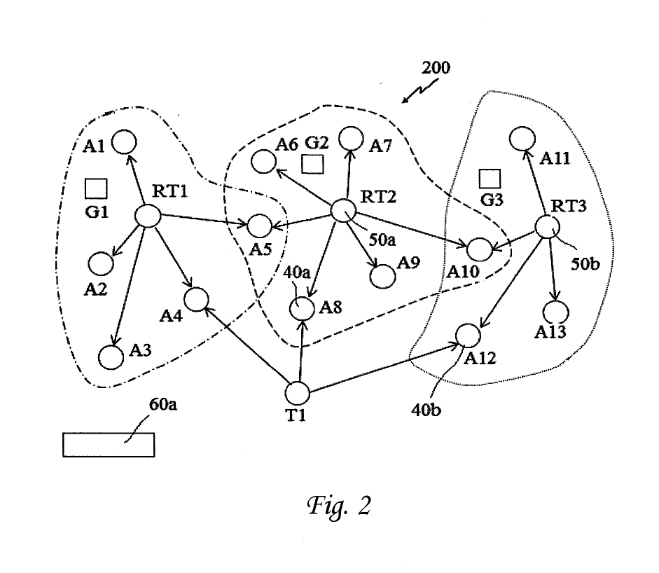

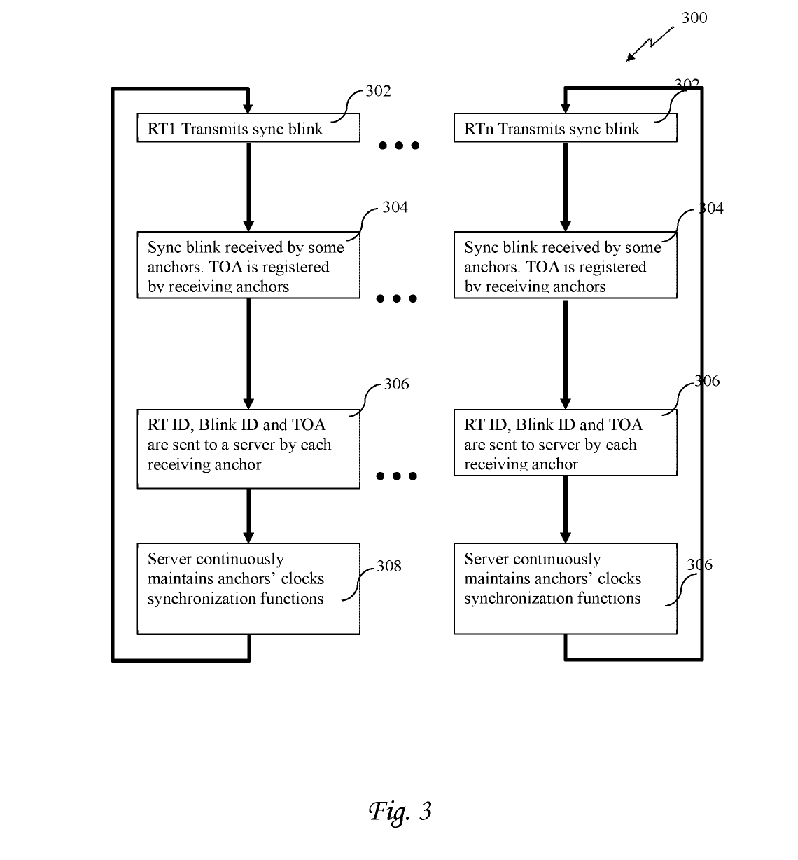

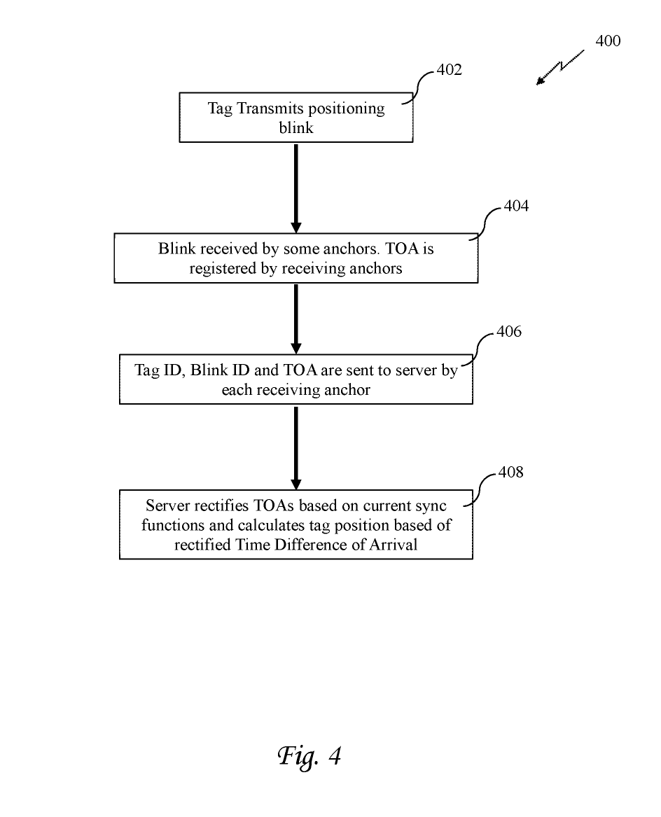

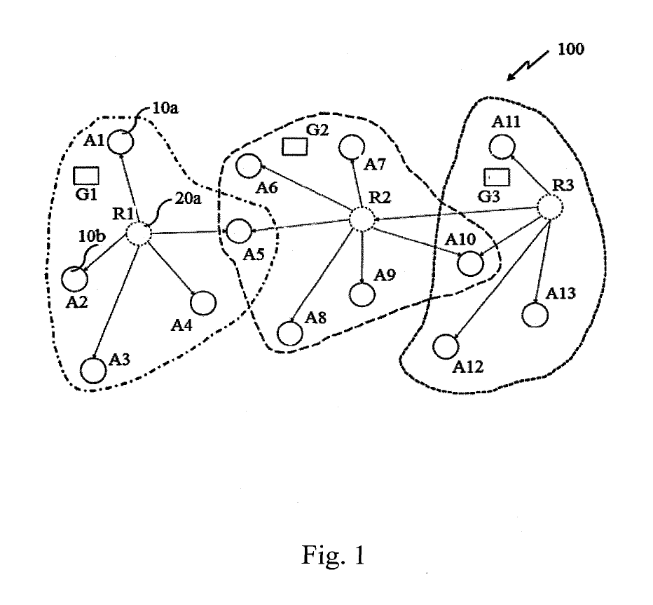

Reference is made to FIG. 1, presenting, in topological form, a schematic and generalized presentation of the present invention environment where said system 100 comprising: a plurality of autonomous reference transmitters RT; a plurality of anchors A installed in a defined area housing said plurality of tag devices; and at least one location engine unit; at least one reference transmitter, being spaced apart at a predetermined cluster separation distance from each other, is adapted to transmit periodically at least one of synchronization blinks, said data comprising reference transmitter identification code and blink identification code; at least one anchor 10 in range of said reference transmitters is adapted to receive said blink. In a TDOA based location system, the TDOA of each pair of anchors is calculated from the reported TOAs of a given positioning blink, that were registered at the anchors. In order to accurately measure the Time Difference of Arrival of a blink message, as disclosed herein, transmitted from a portable tag to any two receiving anchors, there is a need of the anchor clocks to be fully synchronized continuously in real-time once the blink from the tag is received. Once the clocks are properly synchronized, the time stamps, generated by the two anchors and representing the registered time of arrival of the tag's blink, will be subtracted from one another, and suggest the spatial hyperbole on which the tag resides at the moment the blink was transmitted. The presented system comprises clusters of the anchors G1 G2 G3, said each cluster is operable to receive continuous synchronization blinks from a given reference transmitter. Anchors may overlap one or more of said clusters to provide a higher level of redundancy and interconnections between different clusters.

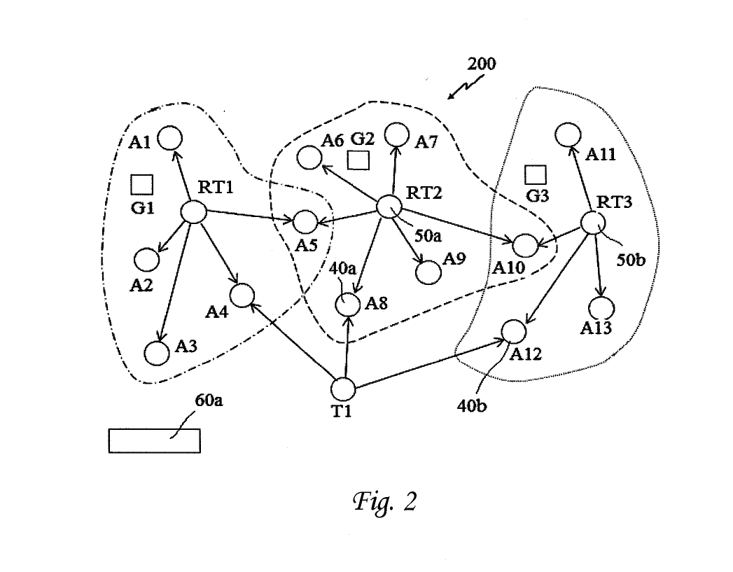

Reference is made to FIG. 2, presenting, in topological form, a schematic and generalized presentation of the present invention environment 200 where said system 100 comprising: a plurality of portable tag devices; a plurality of autonomous reference transmitters installed in a defined area housing said plurality of tag devices T1 30a; a plurality of anchors installed in a defined area housing said plurality of tag devices and said a plurality of autonomous reference transmitters RT2 50a RT3 50b; and at least one location engine unit in a defined area housing said plurality of tag devices, said a plurality of autonomous reference transmitters and said plurality of anchors LEU1 60a;

As presented in FIG. 2 the disclosed system provides, between the anchors that are installed in fixed defined positions, along the defined network area, a cluster of installed in fixed defined positions reference transmitters (RT). The RTs are autonomous units to be operable to transmit sync blink messages in a pre-defined, periodic frequency and not in response to any triggering event, as is disclosed in prior art architectures. Each anchor, receiving any sync blink, registers TOA and transmits the blink data, along with its registered TOA to the system server. Thus the server gets a continuous influx of sync data from all said anchors. This data is used to synchronize the anchors in real-time or off-line manner, when required.

Simultaneously with the continuous synchronization blinks transmitted by RTs and received by anchors, portable tags transmit positioning blinks from time to time. The system discloses the continuous influx of synchronization data is used to position a tag by providing at least two anchors, namely A8 40a and A12 40b; and receiving a positioning blink transmitted by a tag, namely T1 30a.

Disclosed in the present system a synchronization function where t₁ⁱ and t₂ⁱ are defined as the reception times, as registered by A8 40a and A12 40b respectively where i is defined as the blink ID data. The anchor on-board clocks are independent, thus they are not synced between themselves and the subtraction of t₁ⁱ−t₂ⁱ has no physical definition. A reference transmitter, namely RT2 50a, periodically transmits synchronization one or more blinks, received by said two anchors, A8 40a and A12 40b, which continuously transmit the sync data to the server. The server continuously maintains a FIFO stack of sync blink reception times for each anchor, namely t₁^{j} and r₂^{j} where j is defined as the synchronization blink ID data. When the data from the positioning blink arrives at the server, its server is operable to synchronize t1 and t2 to bring their subtraction to provide data associated with the tag's position. The off-line synchronization is achieved by computing a model function f: t₁→t₂ such that t₁=Σaₙ(t₂)ⁿ. Using the reception time stack per anchor, said function parameters aₙ are computed by the server periodically in real-time. Therefore, the server continuously maintains synchronization functions between anchors which are operable to rectify positioning blink reception times, causing the subtraction of the rectified reception times to be informative and meaningful.

The anchors may be operable to synchronize offline even if they do not share a reference transmitter (i.e. they do not receive the same RT and therefore do not share the same cluster). The clock synchronization between two said anchors is achieved by computation of the synchronization functions of each of said anchors to a third anchor, which they both share their RT with. Thus causing such synchronization scheme to be scalable, as long as a synchronization path between any two anchors that requires syncing is maintained. The number and the position of said RTs are set to keep a high level of redundancy which provides system robustness providing continuously more than one path to connect between any two anchors operable to be synchronized.

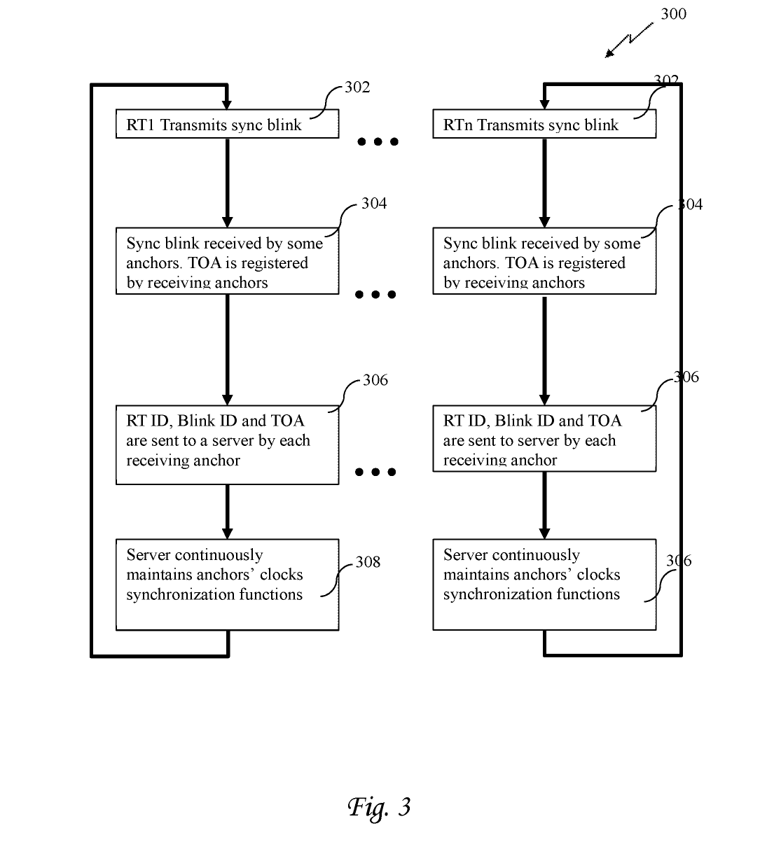

Reference is now made to FIG. 3, presenting a flow diagram illustrating a method for time synchronization in a real-time wireless positioning system 300. Said method comprises, for a number of repetitions, steps of providing a real-time wireless positioning system 100; transmitting periodically one or more of synchronization blinks by one or more reference transmitter devices, said blink comprising reference transmitter identification code and blink identification code 302; receiving, by at least one anchor, said blink 304 and transmitting said blink data to a location engine unit 306; continuously maintaining anchors' clocks synchronization functions, by means of linear or nonlinear regression, based on synchronization blink data influx 308. For the sake of simplicity, some typical functions normally found in a typical transceiver are not shown. Among others those functions include: Synthesizer, DC-DC converter, interfaces to external units, and the like.

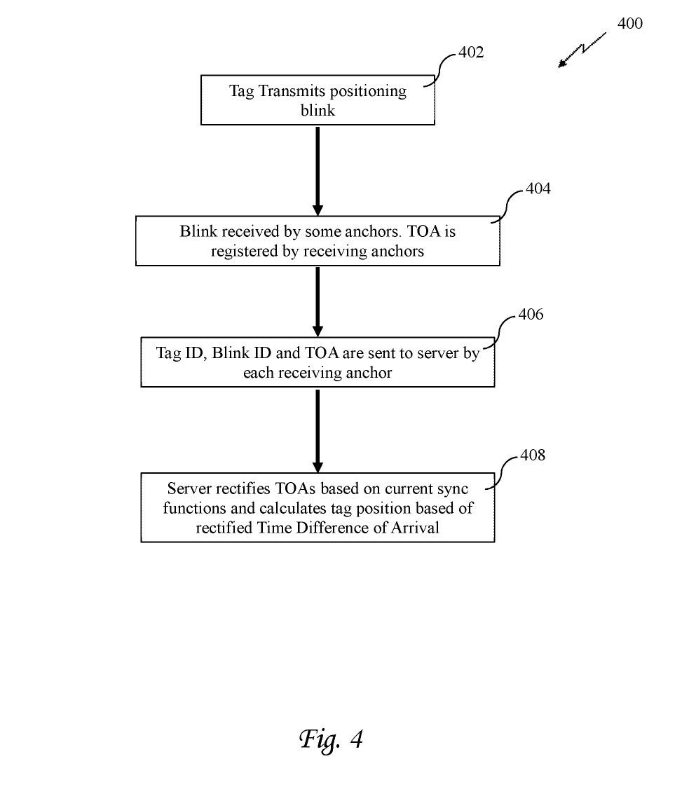

Reference is now made to FIG. 4, presenting a flow diagram illustrating a simultaneous method of calculating tag position in a real-time wireless positioning system 400 to the method disclosed in FIG. 3. Said method comprises, for a number of repetitions, steps of providing a real-time wireless positioning system 100; using said system, transmitting one or more of positioning blinks by tag device when activated 402; receiving, by at least one anchor, said blink 404 and transmitting said blink data to a location engine unit 406; The location engine is then rectifying the reported TOA based on the continuously maintained clock correction functions and calculating a location of the tag device transmitting said positioning blink based on rectified Time Difference of Arrival; continuously maintaining anchors' clocks synchronization functions, by means of linear or nonlinear regression, based on synchronization blink data influx 408.

What is claimed is:

1. A real-time wireless positioning system, comprising:
a. a plurality of portable tag devices;
b. a plurality of autonomous reference transmitters installed in a defined area housing said plurality of tag devices;
c. a plurality of anchors installed in a defined area housing said plurality of tag devices and said a plurality of autonomous reference transmitters; and
d. at least one location engine unit in an area housing said plurality of tag devices, said a plurality of autonomous reference transmitters and said plurality of anchors;
wherein each tag device, being spaced apart at a predetermined cluster separation distance from each other, is adapted to store a unique identification code, each tag device is adapted to transmit one or more of positioning blinks when activated;
wherein at least one reference transmitter, being spaced apart at a predetermined cluster separation distance from each other, is adapted to transmit periodically one or more of synchronization blinks, said one or more of synchronization blinks comprising reference transmitter identification code and blink identification code;
wherein at least one anchor in range of an activated tag device is adapted to receive said synchronization blinks and transmit synchronization blink data, said data comprising its TOA, to at least one location engine unit;
wherein at least one location engine is adapted to receive said synchronization blink data and said positioning blink data transmitted by said at least one anchors in range of said activated tag device and calculate a location of the tag device transmitting said positioning blink based on Time Difference of Arrival;
wherein anchors' clocks synchronization functions are continuously maintained, by means of linear or nonlinear regression, based on synchronization blink data influx.

2. The system of claim 1, wherein said location engine unit periodically maintains clock conversion functions between said plurality of anchors based on synchronization blink TOA data.

3. The system of claim 1, wherein said function comprises a linear interpolation operation.

4. The system of claim 1, wherein said function comprises a non-linear interpolation operation.

5. A method for time synchronization in a real-time wireless positioning system, wherein said method comprising steps of:
a. transmitting one or more of positioning blinks by tag device when activated;
b. transmitting periodically one or more of synchronization blinks, said blink comprising reference transmitter identification code and blink identification code.
c. receiving, by at least one anchor, said blink and transmitting said blink to a location engine unit;
d. receiving said synchronization blinks and transmitting synchronization blink data, said data comprising its TOA, to at least one location engine unit.
e. receiving said synchronization blink data and said positioning blink data transmitted by said at least one anchors in range of said activated tag device and calculating a location of the tag device transmitting said positioning blink based on Time Difference of Arrival.
f. continuously maintaining anchors' clocks synchronization functions, by means of linear or nonlinear regression, based on synchronization blink data influx.

6. The method of claim 5, further comprising a step of periodically maintaining clock conversion functions between said plurality of anchors based on synchronization blink TOA data.

7. The method of claim 5, wherein said function comprises a linear interpolation operation.

8. The method of claim 5, wherein said function comprises a non-linear interpolation operation.

9. An apparatus for time synchronization in a real-time wireless positioning system, comprising:
a. at least one processor; and
b. at least one memory including executable instructions, the at least one memory and the executable instructions being configured to, in cooperation with the at least one processor, cause the device to perform at least the following:
i. transmitting periodically one or more of synchronization blinks, said blink comprising reference transmitter identification code and blink identification code.
ii. receiving, by at least one anchor, said blink and transmitting said blink to a location engine unit;
iii. receiving said synchronization blinks and transmitting synchronization blink data, said data comprising its TOA, to at least one location engine unit.

10. An apparatus for time synchronization in a real-time wireless positioning system, comprising:
a. means for transmitting one or more of positioning blinks by tag device when activated;
b. means for transmitting periodically one or more of synchronization blinks, said blink comprising reference transmitter identification code and blink identification code.
c. means for receiving, by at least one anchor, said blink and transmitting said blink to a location engine unit;
d. means for receiving said synchronization blinks and transmitting synchronization blink data, said data comprising its TOA, to at least one location engine unit;
e. means for receiving said synchronization blink data and said positioning blink data transmitted by said at least one anchors in range of said activated tag device and calculating a location of the tag device transmitting said positioning blink based on Time Difference of Arrival;
f. means for continuously maintaining anchors' clocks synchronization functions, by means of linear or nonlinear regression, based on synchronization blink data influx

11. The apparatus of claim 10, further comprising means of periodically maintaining clock conversion functions between said plurality of anchors based on synchronization blink TOA data.

12. The apparatus of claim 10, wherein said function comprises a linear interpolation operation.

13. The apparatus of claim 10, wherein said function comprises a non-linear interpolation operation.
